(19) United States
(12) Patent Application Publication
(10) Pub. No.: US 2020/0151762 A1
(43) Pub. Date: May 14, 2020

(54) METHOD AND APPARATUS FOR AUTOMATICALLY IDENTIFYING DIGITAL ADVERTISEMENTS

(71) Applicant: Walmart Apollo, LLC, Bentonville, AR (US)

(72) Inventors: Peng Yang, San Jose, CA (US); Jayanth Korlimarla, Sunnyvale, CA (US)

(21) Appl. No.: 16/189,935

(22) Filed: Nov. 13, 2018

(51) Int. Cl. G06Q 30/02; G06F 15/18

(52) U.S. Cl. CPC G06Q 30/0255; G06F 15/18; G06Q 30/0271

(57) ABSTRACT

This application relates to apparatus and methods for determining digital product advertisements for products a customer is more likely to purchase. Historical order data is obtained for orders previously placed by a customer. In some examples, a first value is determined for a first brand based on a purchase date of any of the orders for the customer that include at least one item of the first brand. A second value is determined based on the first value and the purchase date of any orders that include at least one item of a second brand. A brand affinity score for the first brand is determined based on the first value and the second value. In some examples, the brand affinity score is based on a machine learning process. The brand affinity score may determine what brand of a product the customer is more likely to purchase.

### TECHNICAL FIELD

The disclosure relates generally to advertising and, more specifically, to automatically identifying digital advertisements.

### BACKGROUND

An advertisement may be a presentation or communication to promote an item, such as a product or service, for purchase. At least some advertisements are digital advertisements, which include a digital representation of the presentation or communication, such as one displayed on a web site. A sponsor of an advertisement, such as a business, may seek to sell the item in the advertisement. The sponsor may advertise the item in the advertisement to notify potential buyers of the sale of the item, thereby increasing the chances of selling the item. At least some advertising techniques include targeted advertising. As opposed to general advertising that may be indiscriminate, targeted advertising may focus on presenting advertisements to an identified (e.g., specific) audience set. The identified audience set may be a subset of a business's customer base, for example.

At least some digital advertising systems provide for targeted advertising of items to a customer base. For example, at least some digital advertising systems identify an audience set based on previous sales of a same product to a customer base within a date range. These current digital advertising systems, however, have various limitations. For example, they may exclude customers that otherwise would purchase the item if shown the digital advertisement. As a result, the demand for the item may be reduced, and a sale of the item may be lost. As such, there are opportunities to improve digital advertising systems for these and other reasons as well.

### SUMMARY

The embodiments described herein are directed to automatically identifying an audience set of a customer base to whom to digitally advertise an item to. The identified audience set may include customers that have a higher propensity than others of the customer base to purchase the digitally advertised item. The embodiments may solve one or more problems present in the prior art, such as those discussed above. For example, the embodiments may identify customers that will purchase the item if shown the digital advertisement, resulting in increased demand for, and increase in sales of, the digitally advertised product.

In accordance with various embodiments, exemplary systems may be implemented in any suitable hardware or hardware and software, such as in any suitable computing device. For example, in some embodiments, a computing device and a database are provided. The computing device is communicatively coupled to the database and is configured to obtain, from the database, order data for a plurality of orders previously placed by a customer, where each order comprises at least one item and a purchase date. The computing device may determine a first brand affinity value for a first brand based at least on the purchase date of any orders of the plurality of orders that comprise at least one item of the first brand. The computing device may also obtain, from the database, an item category identifying at least the first brand and a second brand. The computing device may determine a second brand affinity value for the item category based at least on the first brand affinity value and the purchase date of any orders of the plurality of orders that comprise at least one item of the second brand. The computing device may then determine a first brand affinity score for the first brand based on the first brand affinity value and the second brand affinity value.

In some examples, a method is provided that includes obtaining, from a database, order data for a plurality of orders previously placed by a customer, where each order of the plurality of orders comprises at least one item and a purchase date. The method further includes determining a first brand affinity value for a first brand based at least on the purchase date of any orders of the plurality of orders that comprise at least one item of the first brand. The method may also include obtaining, from the database, an item category identifying at least the first brand and a second brand. The method may further include determining a second brand affinity value for the item category based at least on the first brand affinity value and the purchase date of any orders of the plurality of orders that comprise at least one item of the second brand. The method may also include determining a first brand affinity score for the first brand based on the first brand affinity value and the second brand affinity value.

In yet other embodiments, a non-transitory computer readable medium has instructions stored thereon, where the instructions, when executed by at least one processor, cause a device to perform operations that include obtaining, from a database, order data for a plurality of orders previously placed by a customer, where each order of the plurality of orders comprises at least one item and a purchase date. The operations may include determining a first brand affinity value for a first brand based at least on the purchase date of any orders of the plurality of orders that comprise at least one item of the first brand. The operations may also include obtaining, from the database, an item category identifying at least the first brand and a second brand. The operations may further include determining a second brand affinity value for the item category based at least on the first brand affinity value and the purchase date of any orders of the plurality of orders that comprise at least one item of the second brand. The operations may also include determining a first brand affinity score for the first brand based on the first brand affinity value and the second brand affinity value.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an automated digital advertisement identification system in accordance with some embodiments;

FIG. 2 is a block diagram of the digital advertisement identification computing device of the automated digital advertisement identification system of FIG. 1 in accordance with some embodiments;

FIG. 3 is a block diagram illustrating examples of various portions of the digital advertisement identification computing device and database of FIG. 1 in accordance with some embodiments;

FIG. 4 is a diagram illustrating example brand affinity scores that may be generated by the digital advertisement identification computing device of FIG. 1 in accordance with some embodiments;

FIG. 5 is a flowchart of an example method that can be carried out by the digital advertisement identification computing device of FIG. 1 in accordance with some embodiments; and

FIG. 6 is a flowchart of another example method that can be carried out by the digital advertisement identification computing device of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

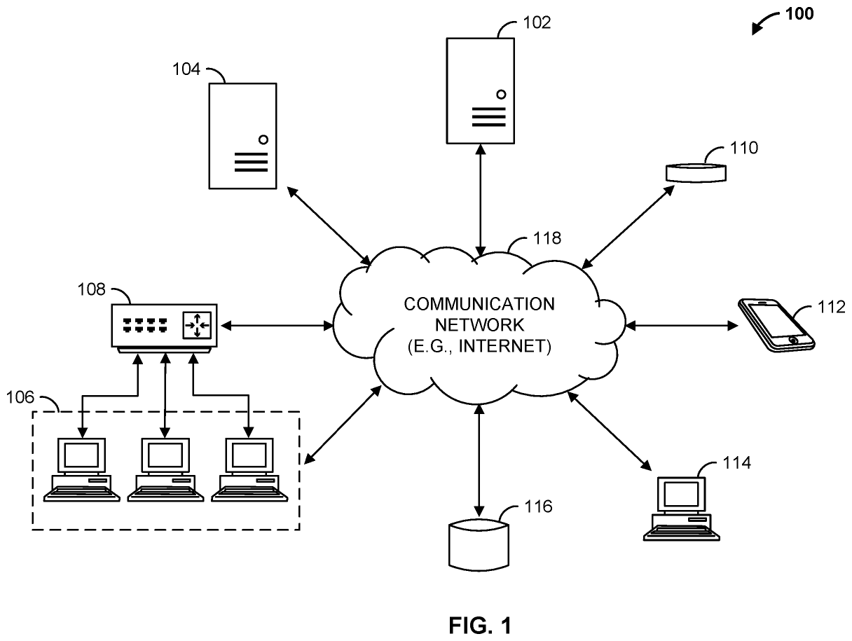

Turning to the drawings, FIG. 1 illustrates a block diagram of an automated digital advertisement identification system 100 that includes a digital advertisement identification computing device 102 (e.g., a server, such as an application server), a web hosting device 104 (e.g., a web server), workstation(s) 106, database 116, and multiple customer computing devices 110, 112, 114 operatively coupled over network 118. Digital advertisement identification computing device 102, web hosting device 104, and multiple customer computing devices 110, 112, 114 can each be any suitable computing device that includes any hardware or hardware and software combination for processing and handling information. In addition, each can transmit data to, and receive data from, communication network 118.

For example, digital advertisement identification computing device 102 can be a computer, a workstation, a laptop, a server such as a cloud-based server, or any other suitable device. Each of multiple customer computing devices 110, 112, 114 can be a mobile device such as a cellular phone, a laptop, a computer, a table, a personal assistant device, a voice assistant device, a digital assistant, or any other suitable device.

Additionally, each of digital advertisement identification computing device 102, web hosting device 104, and multiple customer computing devices 110, 112, 114 can include one or more processors, one or more field-programmable gate arrays (FPGAs), one or more application-specific integrated circuits (ASICs), one or more state machines, digital circuitry, or any other suitable circuitry.

Although FIG. 1 illustrates three customer computing devices 110, 112, 114, automated digital advertisement identification system 100 can include any number of customer computing devices 110, 112, 114. Similarly, automated digital advertisement identification system 100 can include any number of workstation(s) 106, digital advertisement identification computing devices 102, web servers 104, and databases 116.

Workstation(s) 106 are operably coupled to communication network 118 via router (or switch) 108. For example, workstation(s) 106 can communicate with digital advertisement identification computing device 102 over communication network 118. The workstation(s) 106 can allow for the configuration and/or programming of digital advertisement identification computing device 102, such as the controlling and/or programming of one or more processors of digital advertisement identification computing device 102. Workstation(s) 106 may also communicate with web server 104. For example, web server 104 may host one or more web pages, such as a retailer's website. Workstation(s) 106 may be operable to access and program (e.g., configure) the webpages hosted by web server 104.

Digital advertisement identification computing device 102, web server 104, and workstation(s) 106 may be operated by a retailer. Customer computing devices 110, 112, 114 may be computing devices operated by customers of a retailer. Digital advertisement identification computing device 102 is operable to communicate with database 116 over communication network 118. For example, digital advertisement identification computing device 102 can store data to, and read data from, database 116. Database 116 can be a remote storage device, such as a cloud-based server, a memory device on another application server, a networked computer, or any other suitable remote storage. Although shown remote to digital advertisement identification computing device 102, in some examples, database 116 can be a local storage device, such as a hard drive, a non-volatile memory, or a USB stick.

Communication network 118 can be a WiFi network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Digital advertisement identification computing device 102 can also communicate with first customer computing device 110, second customer computing device 112, and Nth customer computing device 114 over communication network 118. Similarly, first customer computing device 110, second customer computing device 112, and Nth customer computing device 114 are operable to communicate with digital advertisement identification computing device 102 over communication network 118. For example, digital advertisement identification computing device 102 can receive data (e.g., messages) from, and transmit data to, first customer computing device 110, second customer computing device 112, and Nth customer computing device 114.

Automated digital advertisement identification system 100 may allow for the generation of customer brand advertisement identification (ID) data that identifies a brand to digitally advertise. For example, and as described in further detail below, digital advertisement identification computing device 102 may generate brand affinity scores for a plurality of brands. In some examples, the brand affinity scores are generated based on the application of one or more machine learning processes to a customer's previous order history. In some examples, the brand affinity scores are generated based on the application of one or more time decay algorithms (e.g., model) to the customer's previous order history. Based on the brand affinity score generated for each of a plurality of brands, digital advertisement identification computing device 102 may identify a brand to digitally advertise. For example, given two similar products for different brands, the product for the brand with the higher brand affinity score may be identified for advertising on a website.

In some examples, brand affinity scores may be used to target customers. For example, customers associated with high brand affinity scores (e.g., scores in the upper 50% of a range) for a given brand may be identified to advertise products for that brand. For example, customers with higher brand affinity scores may be targeted to assure the customer's loyalty to that brand. In some examples, customers associated with brand affinity scores in midrange (e.g., around 0.5 for a range of 0 to 1) for a given brand may be identified to advertise products for that brand. For example, customers with midrange brand affinity scores may be targeted to increase the customer's loyalty to that brand. In some examples, customers associated with low brand affinity scores in midrange (e.g., scores in the lower 50% of a range) for a given brand may be identified to advertise products for that brand. For example, customers with lower brand affinity scores may be targeted to decrease churn for products under that brand.

In some examples, the brand is identified based on the brand affinity score as well as other considerations, such as an advertising price associated with the brand. For example, a retailer may receive compensation for purchases made through the selection of a digital advertisement, such as an advertisement on a webpage. The retailer may receive one price for products or services that are advertised and sold under one brand (brand A), and may receive another price (e.g., higher, or lower price) for products or services that are advertised and sold under another brand (brand B). Digital advertisement identification computing device 102 may determine whether to digitally advertise a product under brand A or under brand B based on the brand affinity score and the advertising price for each brand.

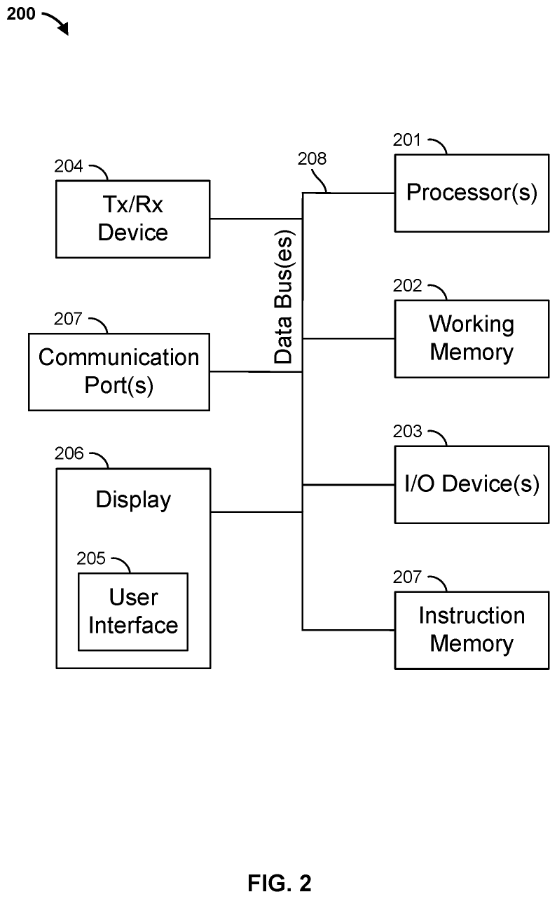

FIG. 2 illustrates the digital advertisement identification computing device 102 of FIG. 1. Digital advertisement identification computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of digital advertisement identification computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as data related to a customer's previous order history.

Display 206 can display user interface 205. User interfaces 205 can enable user interaction with digital advertisement identification computing device 102. For example, user interface 205 can be a user interface for an application that allows for the viewing of semantic representations of user queries. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 digital advertisement identification computing device 102 will be operating in. Processor(s) 201 is operable to receive data from, or send data to, a network, such as communication network 118 of FIG. 1, via transceiver 204.

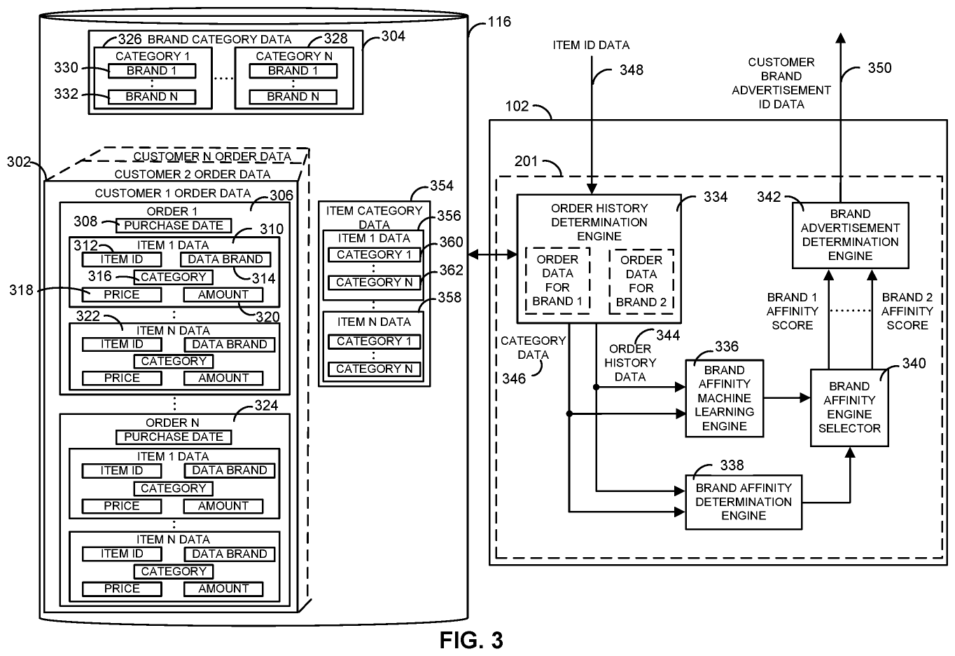

FIG. 3 is a block diagram illustrating examples of various portions of the digital advertisement identification computing device 102 and database 116 of FIG. 1. As indicated in the figure, digital advertisement identification computing device 102 includes order history determination engine 334, brand affinity machine learning engine 336, brand affinity determination engine 338, brand affinity engine selector 340, and brand advertisement determination engine 342. Each of these engines may be implemented, for example, in hardware, or in hardware and software, as in one or more processors executing executable instructions that may be store in instruction memory 207 of FIG. 2.

Order history determination engine 334 may be configured to receive item ID data 348, which may be a digital advertising request that indicates a customer and/or an item, such as a product or service, or type of item, to be digitally advertised to the customer. For example, item ID data 348 may indicate an item number of an item and a customer number. Based on item ID data 348, order history determination engine 334 may obtain item category data 354 from database 116 to determine one or more categories for the indicated item or type of item. An item category may identify any group of goods or services. For example, table 1 below illustrates example item categories:

TABLE 1

| | |
|---|---|
| CAT PANS AND ACCESSORIES | VEGETABLES |
| CAT LITTER | AUTO PARTS |
| VIDEO GAME ACCESSORIES | CLEANING EQUIPMENT |
| VIDEO GAME SOFTWARE | FROZEN FOODS |
| VIDEO GAME INTERACTIVE | BREAD |
| WASHER FLUID | COMPUTERS |
| ALL PURPOSE CLEANERS | COMPUTER REPAIR SERVICES |
| TRAINING PANTS | AUTO REPAIR SERVICES |
| WIPES | LAUNDRY SERVICES |
| DIAPERS | FINANCIAL SERVICES |
| FRUITS | GASOLINE SERVICES |

As indicated in FIG. 3, item category data 354 includes category data for a plurality of items, such as first item data 356 up to Nth item data 358. The data for the plurality of items may each include one or more item categories. For example, first item data 356 includes one or more categories such as first category 360 and Nth category 362. Order history determination engine 334 may obtain item category data 354 that corresponds to an item identified by item ID data 348. For example, assuming item ID data 348 identifies a first item, order history determination engine 334 may obtain first item data 356, which identifies first category 360 and Nth category 362, each corresponding to the first item. In some examples, the first item may correspond to just one category.

Database 116 further includes brand category data 304, which may identify one or more brands associated with one or more item categories. For example, brand category data 304 includes first brand category data 326 up to Nth brand category data 328. Each of first brand category data 326 up to Nth brand category data 328 is associated with one or more brands. In this example, first brand category data 326 is associated at least with first brand 330 and Nth brand 332.

Order history determination engine 334 may determine and obtain brands for an item based on brands identified in brand category data 304 that are associated with the categories identified for the item by item category data 354. For example, assuming order history determination engine 334 obtains first item data 356 which identifies first category 360, order history determination engine 334 may obtain first category data 326 from brand category data 304 (e.g., assuming first category 360 corresponds to (e.g., is the same as) first category data 326), which identifies at least first brand 330 and Nth brand 332. Similarly, assuming order history determination engine 334 obtains first item data 356 which identifies Nth category 362, order history determination engine 334 may obtain Nth category data 328 (e.g., assuming Nth category 362 corresponds to (e.g., is the same as) Nth category data 328), which may identify one or more brands. In some examples, order history determination engine 334 compares the categories identified by the obtained item category data 354 to the category data 326, 328 of brand category data 304 to determine what category data 326, 328 to obtain. Order history determination engine 334 obtains the category data 326, 328 to determine under what brands, such as first brand 330 and Nth brand 332, are items in the same category as the item identified by item ID data 348 sold.

Database 116 may further include customer order data 302, which identifies previous purchase orders for one or more customers, such as a customer identified by item ID data 348. For each customer, customer order data 302 may include one or more purchase orders, such as purchase order 306 and purchase order 324. Each purchase order 306, 324 may include a purchase date 308, and item data 310, 322 for each item purchased in the corresponding purchase order 306, 324. The purchase date 308 identifies the date and/or time of the corresponding purchase order 306, 324. Each of item data 310, 322 may include one or more of an item ID 312, a brand 314, a category 316, a price 318, and a purchase amount 320 associated with the corresponding purchase order 306, 324.

In some examples, customer order data 302 additionally, or alternatively, includes other customer product interaction data. For example, customer order data 302 may include data related to online search activities conducted by a customer, such as searching for a brand or product. Customer order data 302 may also include website browse activity data, such as data related to what brand or product a customer viewed or added to their online shopping cart (e.g., even though they may not have purchased the product).

Order history determination engine 334 may obtain customer order data 302 for the customer identified by item ID data 348. For example, if item ID data 348 identifies a first customer, order history determination engine 334 may obtain first customer order data 303 corresponding to that first customer.

Order history determination engine 334 may determine which purchase orders 306, 324 include at least one item that is associated with an item category as determined above. For example, order history determination engine 334 may compare the category for each purchase order 306, 324, such as category 318, to the obtained categories of brand category data 304, such as first category data 326. If the categories match, order history determination engine 334 may determine that the corresponding purchase order includes at least one item that is associated with the determined item category. Order history determination engine 334 provides the data identifying the purchase orders that include at least one item that is associated with the item category as order history data 344. Order history determination engine 334 may also provide data identifying the one or more brands associated with the item category, such as first brand 330 and Nth brand 332, as category data 346.

In some examples, order history determination engine 334 may compare the brand for each purchase order 306, 324, such as brand 314, to the brands of the obtained categories to determine if the corresponding purchase order includes at least one item under the same brand as the determined brand. In some examples, the categories must correspond to (e.g., be the same as) each other, and the brands must also correspond to each other.

If order history determination engine 334 determines that the item categories correspond to each other and, in some examples, the brands correspond to each other, order history determination engine 334 provides the order history data 344 for each corresponding purchase order 306, 324. In other words, order history determination engine 334 provides order history data 344 for items in purchase orders 306, 324 that are in a same category as a category associated with the item indicated by item ID data 348. Order history determination engine 334 may also provide category data 346 identifying one or more brands associated with the same category.

Order history determination engine 334 may provide order history data 344 and category data 346 to brand affinity machine learning engine 336 and brand affinity determination engine 338. Brand affinity machine learning engine 336 may apply one or more machine learning processes to one or more of order history data 344 and category data 346 to determine a brand affinity score for one or more brands. The machine learning processes may include, but are not limited to, ordinary least squares regression, ridge regression, support vector regression (SVRs), such as SVR using a linear kernel, random forest, XGBoost, deep neural network, or any other suitable machine learning process. For example, brand affinity machine learning engine 336 may apply a machine learning process to order data for a first brand to determine a first brand affinity score. Similarly, brand affinity machine learning engine 336 may apply a machine learning process to order data for a second brand to determine a second brand affinity score.

The machine learning processes applied by affinity machine learning engine 336 may be trained using test data representing one or more of order data for a brand and category data. For example, affinity machine learning engine 336 may obtain test data from, for example, database 116, and train the one or more machine learning processes. In some examples, affinity machine learning engine 336 applies one or more weights to different portions of the test data. affinity machine learning engine 336 may then apply the one or more weights to order history data 344 and/or category data 346 when applying the one or more machine learning processes.

Brand affinity machine learning engine 336 provides the one or more brand affinity scores to brand affinity engine selector 340, which is operable to select and provide brand affinity scores from brand affinity machine learning engine 336 and brand affinity determination engine 338.

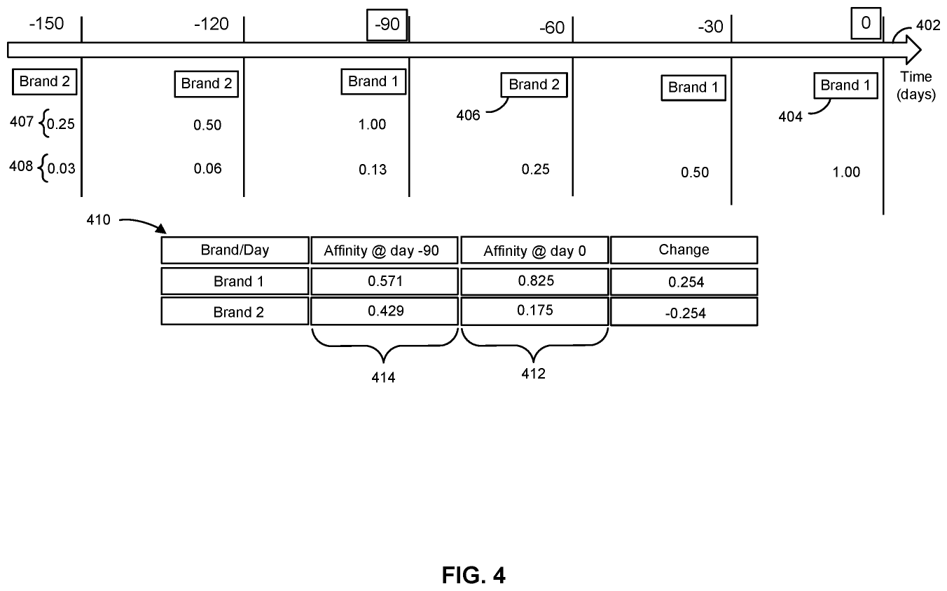

Brand affinity determination engine 338 determines one or more brand affinity scores based on the order history data 344 and category data 346 obtained from order history determination engine 334. As described further with respect to FIG. 4 below, brand affinity determination engine 338 may determine the brand affinity score for a brand based on applying one or more algorithms based on a time decay weighting of the purchase orders for one or more brands. For example, for each brand identified by category data 346, brand affinity determination engine 338 may apply an algorithm to order history data 344 that includes a time decay weighting of the purchase orders identified by order history data 344 that include an item of that brand.

Brand advertisement determination engine 342 is operable to obtain the brand affinity scores from brand affinity engine selector 340 to determine customer brand advertisement ID data 350, which identifies a brand to digitally advertise. Customer brand advertisement ID data 350 may identify, for example, a brand, such as brand 314, of the product identified by item ID data 348 to digitally advertise, such as on a webpage. In some examples, brand advertisement determination engine 342 selects the brand with the highest brand affinity score.

In some examples, the brand affinity scores are one of two or more inputs to one or more algorithms applied by brand advertisement determination engine 342 to determine customer brand advertisement ID data 350. For example, brand advertisement determination engine 342 may identify a price associated with each brand. Data identifying the advertising prices associated with each brand may be stored, for example, in database 116. Brand advertisement determination engine 342 may obtain the advertising prices and determine the brand under which to digitally advertise the product identified by item ID data 348 based on the brand affinity score and the advertising price for the multiple brands. For example, brand advertisement determination engine 342 may multiply the brand affinity score and the advertising for that brand to determine an adjusted score for that brand. The brand with the highest adjusted score may be the brand selected to be advertised.

FIG. 4 illustrates example brand affinity scores that may be generated by the brand affinity determination engine 338 of digital advertisement identification 102. The illustration includes timeline 402 which, in this example, is illustrated in 30-day time periods. Specifically, the timeline begins at day 0, and goes back in time in periods of 30 days (i.e., −30, −60, −90, −120, and −150 days). Timeline 402 further indicates time decayed at each of the 30 day periods. The time decayed values may be computed based on the equation below:

Tdv=Idv*(dr)^{dfp/halflife}, (eq. 1)

where:
Tdv is the time decay value for a day;
Idv is the initial decay value (e.g., in this example, 1.00);
dr is the decay rate (e.g., in this example, 0.50 (i.e., 50%)); and
dfp is the number of days since the purchase
halflife is the number of days used for the halflife decay factor (e.g., in this example 30 days)

For example, timeline 402 indicates that at day 0 the initial decay value (Idv) is 1.0. In this example, the decay rate is 50%, and the halflife is 30 days. At day −30, which is 30 days before day 0, the time decay value (Tdv) is 0.50. Using the equation above, this was computed as Tdv₋₃₀=1.0*0.50^{30/30}. At day −60, which is 60 days before day 0, the time decay value is 0.25. This was computed as Tdv₋₆₀=1.0*0.50^{60/30}. At day −90, which is 90 days before day 0, the time decay value is 0.25. This was computed as Tdv₋₆₀=1.0*0.50^{60/30}. At day −90, which is 60 days before day 0, the time decay value is 0.13. This was computed as Tdv₋₆₀=1.0*0.50^{90/30}. At day −150, which is 150 days before day 0, the time decay value is 0.03. This was computed as Tdv₋₆₀=1.0*0.50^{120/130}.

Timeline 402 further indicates a purchase of a product of a first brand 404 and a purchase of a similar product of a second brand 406. For purposes of this example, the products of the first brand 404 and the second brand 406 are assumed to be in a same item category, such as an item category as described above. For example, products of the same item category are produced under the first brand 404 and the second brand 406. In this example, timeline 402 illustrates that that at day 0, a product for first brand 404 was purchased. Timeline 402 also indicates that the same product for the same first brand 404 was purchased 30 days before day 0, 90 days before day 0, and 150 days before day 0. Similarly, timeline 402 indicates that a similar product, but under the second brand 406, was purchased 60 days before day 0, and 120 days before day 0.

Table 410 indicates brand affinity scores 412 that may generated by, for example, the digital advertisement identification computing device 102 of FIG. 1. In this example, the brand affinity scores 412 are generated based a time decay weighting of the purchase orders for first brand 404 and second brand 406 calculated from day 0. Specifically, as noted above, the time decay values 408, which begin at day 0, and the time decay values 407, which begin at day −90, are based on a 50% time-based decay for each 30-day time period. Time decay values 408 represent time decay values starting from day 0, and time decay values 407 represent time decay values starting at a previous point in time, in this example, day −90.

The brand affinity scores are generated based on a total brand affinity value for a particular brand over a period of time and a total brand affinity value for all brands (i.e., for brands that include products in a same or similar item category). In this example, the brand affinity scores are generated based on the following equation:

BASₓ=BAVₓ(BAV₁+BAV₂), (eq. 2)

where:
BASₓ is the brand affinity score for a particular brand (here, Brand 1 or Brand 2);
BAVₓ is the brand affinity value for a particular brand for a period of time;
BAV₁ is the brand affinity value for brand 1 for a period of time; and
BAV₂ is the brand affinity value for brand 2 for a period of time.

In this example, the brand affinity values are calculated based on the purchase order history and time decay values indicated by timeline 402. For every purchase made in a 30-day time period for a particular brand, the time decay value for that period is added to a total. For example, the brand affinity value for the first brand 404 (BAV₁), using time decay values 408 which are calculated from day 0, is 1.63, because a product for the first brand 404 was purchased in the first, second, and second, fourth periods. Similarly, the brand affinity value for the second brand 406, again using time decay values 408, is 0.34, because the product for the second brand 406 was purchased in the third, fifth, and sixth time periods.

The brand affinity scores 412 may then be determined based on the brand affinity value for a particular brand and the brand affinity for all brands. For example, in this example the brand affinity score 412 for the first brand 404 calculated from day 0 is about 0.825 (1.63/(1.63+0.34)). The brand affinity score 412 for the second brand 406 calculated at day 0 is about 0.175 (0.34/(1.63+0.34)). Thus, in this example, the brand affinity score 412 for the first brand 404 is greater than the brand affinity score 412 for the second brand 406, which in some examples indicates that a customer is more likely to purchase a product of first brand 404 over a similar product of second brand 406.

Table 410 also indicates brand affinity scores 414 calculated from day −90 (e.g., going back 90 days from day 0). In other words, digital advertisement identification computing device 102 may generate brand affinity scores at a previous point in time. AT day −90, the brand affinity value for first brand 404 is 1, as a product under first brand 404 was purchased only in the first time period (where time periods begin from day −90, e.g., first time period is the time period from −90 days to −119 days). The brand affinity value for second brand 406 is 0.75 (0.50+0.25), as a similar product in a same or similar item category as the product for first brand 404 was purchased in the second and third time periods.

The brand affinity scores 414 may be determined based on the brand affinity value for a particular brand and the brand affinity for all brands. For example, in this example the brand affinity score 414 for the first brand 404 calculated from day −90 is about 0.571 (1.00/(1.00+0.75)). The brand affinity score 414 for the second brand 406 calculated at day −90 is about 0.429 (0.75/(1.00+0.75)). Thus, in this example, 90 days prior to day 0, the brand affinity score 414 for the first brand 404 was greater than the brand affinity score 412 for the second brand 406, which in some examples indicates that a customer was more likely to purchase a product of first brand 404 over a similar product of second brand 406.

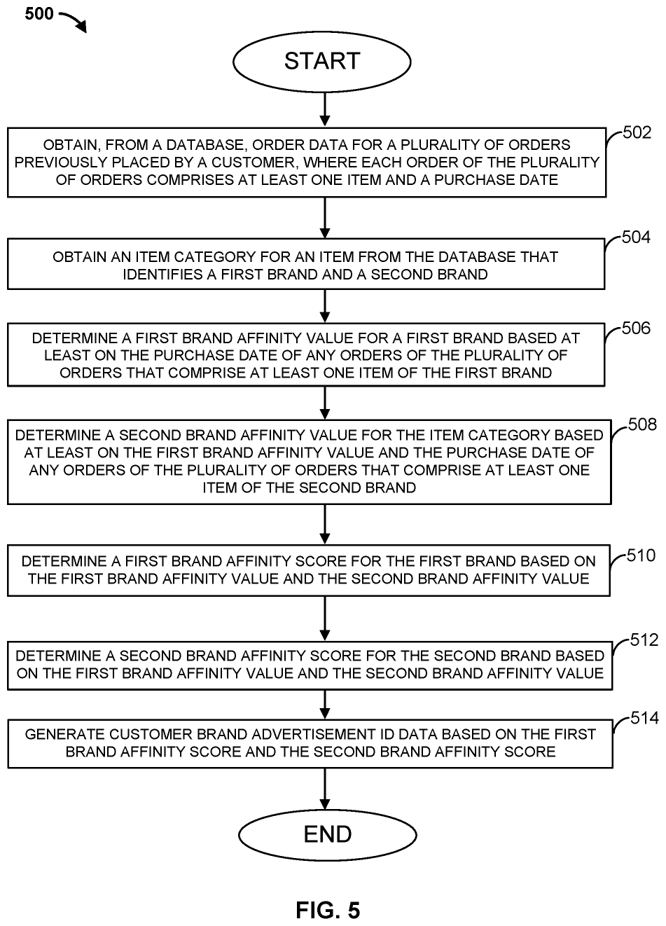

FIG. 5 is a flowchart of an example method 500 that can be carried out by the digital advertisement identification computing device 102 of FIG. 1. At step 502, order data for a plurality of orders previously placed by a customer is obtained from a database. For example, the order data may be customer order data 302 obtained from database 116, as described above with respect to FIG. 3. Each order of the plurality of orders may include at least one item that was purchased, and a corresponding purchase date for the order. Proceeding to step 504, an item category for an item is obtained from the database. For example, digital advertisement identification computing device 102 may obtain first brand category 326 from brand category data 304 based on item ID data 348 as described above with respect to FIG. 3. The item category may identify at least a first brand and a second brand.

At step 506, a first brand affinity value for the first brand is determined based at least on the purchase date of any orders of the plurality of orders that comprise at least one item of the first brand. For example, digital advertisement identification computing device 102 may determine which orders of the obtained plurality of orders in step 502 include an item of the first brand. Digital advertisement identification computing device 102 may then compute the first brand affinity value by applying a time decay algorithm based on the orders that include items of the first brand, such as described above with respect to equation 1 in FIG. 4.

At step 508, a second brand affinity value for the item category is determined based at least on the first brand affinity value and the purchase date of any orders of the plurality of orders that comprise at least one item of the second brand. For example, digital advertisement identification computing device 102 may determine which orders of the obtained plurality of orders in step 502 include an item of the second brand. Digital advertisement identification computing device 102 may then compute the second brand affinity value by applying a time decay algorithm based on the orders that include items of the second brand, such as described above with respect to equation 1 in FIG. 4.

At step 510, a first brand affinity score for the first brand is determined based on the first brand affinity value and the second brand affinity value. For example, the first brand affinity score may be determined based on the application of equation 2 described above with respect to FIG. 4. At step 512, a second brand affinity score for the second brand is determined based on the first brand affinity value and the second brand affinity value. Although in this example the first brand affinity score and the second brand affinity score are determined based on two brand affinity values, in other examples they may be based on any number of brand affinity values.

At step 514, customer brand advertisement ID data is generated based at least on the first brand affinity score and the second brand affinity score. For example, digital advertisement identification computing device 102 may generate customer brand advertisement ID data 350 as described above with respect to FIG. 3. Customer brand advertisement ID data may identify which brand, the first brand or the second brand, should be advertised to the customer.

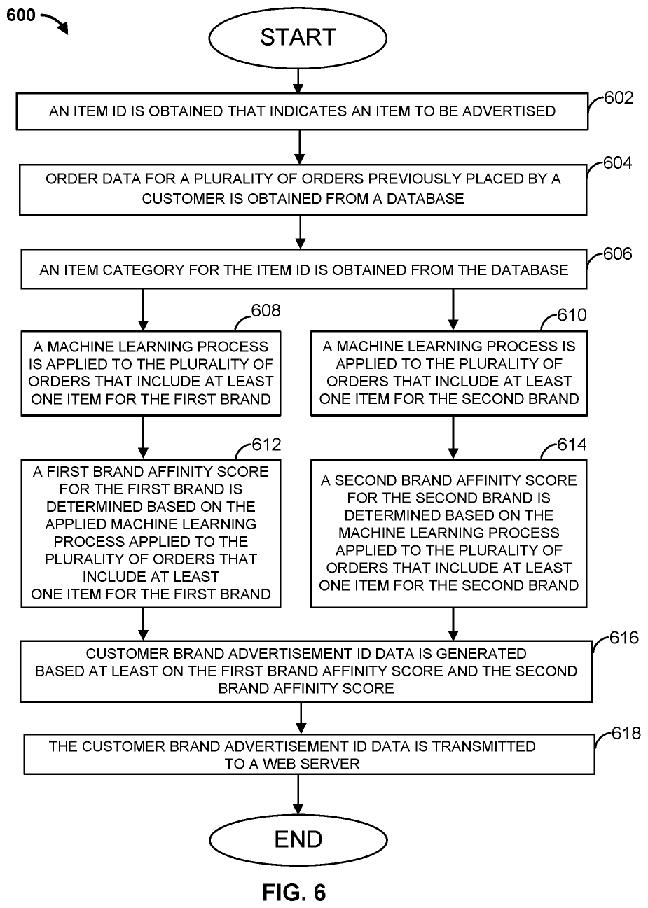

FIG. 6 is a flowchart of another example method 600 that can be carried out by the digital advertisement identification computing device 102 of FIG. 1. At step 602, an item ID is obtained that indicates an item to be advertised. For example, digital advertisement identification computing device 102 may receive item ID data 348 as described above with respect to FIG. 3.

At step 604, order data for a plurality of orders previously placed by a customer is obtained from a database. For example, digital advertisement identification computing device 102 may obtain customer order data 302 from database 116, as described above with respect to FIG. 3. Each order of the plurality of orders may include at least one item that was purchased, and a corresponding purchase date for the order. At step 606, an item category for the item ID is obtained from the database. For example, digital advertisement identification computing device 102 may obtain first brand category 326 from brand category data 304 as described above with respect to FIG. 3. The item category may identify at least a first brand and a second brand.

At step 608, a machine learning process is applied to the plurality of orders that include at least one item for the first brand. For example, the machine learning process may include one or more of ordinary least squares regression, ridge regression, support vector regression, random forest, XGBoost, deep neural network, or any other suitable machine learning process. Similarly, at step 610 a machine learning process is applied to the plurality of orders that include at least one item for the second brand.

At step 612, a first brand affinity score for the first brand is determined based on the applied machine learning process applied to the plurality of orders that include at least one item for the first brand. At step 614, a second brand affinity score for the second brand is determined based on the machine learning process applied to the plurality of orders that include at least one item for the second brand.

At step 616, customer brand advertisement ID data is generated based at least on the first brand affinity score and the second brand affinity score. For example, digital advertisement identification computing device 102 may generate customer brand advertisement ID data 350 as described above with respect to FIG. 3. Customer brand advertisement ID data may identify which brand, the first brand or the second brand, should be advertised to the customer. Proceeding to step 618, the customer brand advertisement ID data is transmitted to a web server, such as the web server 104 of FIG. 1.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device communicatively coupled to a database and configured to:
obtain, from the database, order data for a plurality of orders previously placed by a customer, wherein each order of the plurality of orders comprises at least one item and a purchase date;
determine a first brand affinity value for a first brand based at least on the purchase date of any orders of the plurality of orders that comprise at least one item of the first brand;
obtain, from the database, an item category identifying at least the first brand and a second brand;
determine a second brand affinity value for the item category based at least on the first brand affinity value and the purchase date of any orders of the plurality of orders that comprise at least one item of the second brand; and
determine a first brand affinity score for the first brand based on the first brand affinity value and the second brand affinity value.

2. The system of claim 1, wherein the computing device is configured to determine the first brand affinity value based on a first time decay weighting of first orders of the plurality of orders that comprise at least one item of the first brand, wherein the first time decay weighting is based on the purchase date of the first orders.

3. The system of claim 2, wherein the computing device is configured to determine the second brand affinity value based on:
the first time decay weighting of the first orders of the plurality of orders that comprise the at least one item of the first brand; and
a second time decay weighting of second orders of the plurality of orders that comprise at least one item of the second brand.

4. The system of claim 3, wherein:
the first time decay weighting is based on the purchase dates of the first orders and a time decay value; and
the second time decay weighting is based on the purchase dates of the second orders and the time decay value.

5. The system of claim 4, wherein the decay value is 50%.

6. The system of claim 1, wherein determining the first brand affinity score for the first brand comprises dividing the first brand affinity value by the sum of the first brand affinity value and the second brand affinity value.

7. The system of claim 1, wherein the computing device is further configured to:
determine a second brand affinity score for the second brand; and
determine a customer brand advertisement identification for the customer based on the first brand affinity score and the second brand affinity score.

8. The system of claim 7, wherein determining the customer brand advertisement identification is further based on a first advertising price associated with the first brand and a second advertising price associated with the second brand.

9. A method comprising:
obtaining, from a database, order data for a plurality of orders previously placed by a customer, wherein each order of the plurality of orders comprises at least one item and a purchase date;
determining a first brand affinity value for a first brand based at least on the purchase date of any orders of the plurality of orders that comprise at least one item of the first brand;
obtaining, from the database, an item category identifying at least the first brand and a second brand;
determining a second brand affinity value for the item category based at least on the first brand affinity value and the purchase date of any orders of the plurality of orders that comprise at least one item of the second brand; and
determining a first brand affinity score for the first brand based on the first brand affinity value and the second brand affinity value.

10. The method of claim 9 wherein determining the first brand affinity value is further based on a first time decay weighting of first orders of the plurality of orders that comprise at least one item of the first brand, wherein the first time decay weighting is based on the purchase date of the first orders.

11. The method of claim 10 wherein determining the second brand affinity value is further based on:
the first time decay weighting of the first orders of the plurality of orders that comprise the at least one item of the first brand; and
a second time decay weighting of second orders of the plurality of orders that comprise at least one item of the second brand.

12. The method of claim 11 wherein:
the first time decay weighting is based on the purchase dates of the first orders and a time decay value; and
the second time decay weighting is based on the purchase dates of the second orders and the time decay value.

13. The method of claim 9 wherein determining the first brand affinity score for the first brand comprises dividing the first brand affinity value by the sum of the first brand affinity value and the second brand affinity value.

14. The method of claim 9 further comprising:
determining a second brand affinity score for the second brand; and
determining a customer brand advertisement identification for the customer based on the first brand affinity score and the second brand affinity score.

15. The method of claim 14 wherein determining the customer brand advertisement identification is further based on a first advertising price associated with the first brand and a second advertising price associated with the second brand.

16. A non-transitory computer readable medium having instructions stored thereon, wherein the instructions, when executed by at least one processor, cause a device to perform operations comprising:
obtaining, from a database, order data for a plurality of orders previously placed by a customer, wherein each order of the plurality of orders comprises at least one item and a purchase date;
determining a first brand affinity value for a first brand based at least on the purchase date of any orders of the plurality of orders that comprise at least one item of the first brand;
obtaining, from the database, an item category identifying at least the first brand and a second brand;
determining a second brand affinity value for the item category based at least on the first brand affinity value and the purchase date of any orders of the plurality of orders that comprise at least one item of the second brand; and
determining a first brand affinity score for the first brand based on the first brand affinity value and the second brand affinity value.

17. The non-transitory computer readable medium of claim 16 further comprising instructions stored thereon that, when executed by at least one processor, further cause the device to perform operations comprising:
determining the first brand affinity value based on a first time decay weighting of first orders of the plurality of orders that comprise at least one item of the first brand, wherein the first time decay weighting is based on the purchase date of the first orders.

18. The non-transitory computer readable medium of claim 17 further comprising instructions stored thereon that, when executed by at least one processor, further cause the device to perform operations comprising:
determining the second brand affinity value based on:
the first time decay weighting of the first orders of the plurality of orders that comprise the at least one item of the first brand; and
a second time decay weighting of second orders of the plurality of orders that comprise at least one item of the second brand.

19. The non-transitory computer readable medium of claim 16 further comprising instructions stored thereon that, when executed by at least one processor, further cause the device to perform operations comprising:
determining a second brand affinity score for the second brand; and
determining a customer brand advertisement identification for the customer based on the first brand affinity score and the second brand affinity score.

20. The non-transitory computer readable medium of claim 19 further comprising instructions stored thereon that, when executed by at least one processor, further cause the device to perform operations comprising:
determining the customer brand advertisement identification based on a first advertising price associated with the first brand and a second advertising price associated with the second brand.
